(19) United States
(12) Patent Application Publication
(10) Pub. No.: US 2013/0163897 A1
(43) Pub. Date: Jun. 27, 2013

(54) HOLOGRAPHIC MATRIX, SYSTEM OF HOLOGRAPHIC PERSONALIZATION OF ID CARDS AND SYNTHESIS OF HOLOGRAMS OF DESIRED VISUAL PROPERTIES AND METHOD OF PRODUCTION THEREOF

(71) Applicants: Petr Vizdal, Rez (CZ); Petr Tobiska, Rez (CZ); Libor Kotacka, Rez (CZ)

(72) Inventors: Petr Vizdal, Rez (CZ); Petr Tobiska, Rez (CZ); Libor Kotacka, Rez (CZ)

(21) Appl. No.: 13/700,394

(22) PCT Filed: May 26, 2011
(86) PCT No.: PCT/EP2011/058690

§ 371 Date: Mar. 11, 2013

(30) Foreign Application Priority Data
May 28, 2010 (GB) 1008955.5

(51) Int. Cl. G03H 1/08

(52) U.S. Cl. CPC G03H 1/08
USPC 382/284; 359/9; 264/1.31

(57) ABSTRACT

The invention provides for both a composite image field for verification and/or security applications and including a plurality of sets of image elements, wherein members of each set are from the same one of a respective plurality of images and are spaced and located within the composite image in a manner seeking to avoid those of another set, the composite image being formed by the adjacent location of the spaced elements and wherein the spacing and location is in a defined manner serving to create a security key; and also a related composite optical element for verification and/or security applications and including a plurality of sets of optical elements, the members of each set sharing die same optical properties and spaced and located within the composite element in a manner seeking to avoid those of another set, the composite optical element being formed by the adjacent location of the spaced elements and wherein the spacing and location is in a manner defined for providing a security key.

The present invention relates to an optical device and method of manufacture and, in particular, to a holographic matrix, system of holographic personalization of ID cards and synthesis of holograms of desired visual properties and method of production thereof.

It is known from the prior art that holograms can be originated by means of several technologies, e.g. optically as conventional holography, some macro- or micro-pixel assisted techniques like the so-called dot-matrix technique, or direct laser, or electron beam lithography. The present invention provides for a substantially different approach of synthesis of the visually observable patterns.

The basic principles of holography are of course known from several books, such as for example, P. Hariharan, Optical Holography. 2^{nd} ed. Cambridge University Press (1996).

Particularly effective synthetic origination of such elements can be achieved such as by exploiting electron-beam lithography and as discussed in Ryzi Z. et al., U.S. Pat. No. 7,435,979. Such synthetic origination can advantageously allow for a very complex shaping of the grooves arising from variation in aspects such as period and the thickness of the lines creating the grooves etc., and as is known from Ryzi Z. et al., WO 2006/013215 A1. In consideration of the present invention, it should be appreciated that the content of the above-mentioned published documents is incorporated herein by reference.

However, such known devices and methods of their production exhibit certain characteristics as regards the nature of the images that can be produced, particularly when used in a security context and which might not be best suited to various application scenarios.

The present invention seeks to provide for an optical device, and related method of formation, offering possible synthetic origination of elements, with characteristics particularly for security/verification purposes, and having advantages over known such devices and methods.

According to one aspect of the invention there is provided a composite image pattern for verification and/or security applications and comprising a plurality of sets of image elements, members of each set relating to a respective plurality of images and being spaced and located within the composite image in a manner seeking to avoid those of another set, the composite image being formed by the adjacent location of the spaced elements and wherein the spacing and location is in a defined manner serving to create a security key.

While in one example the said respective plurality of images can be unrelated, it is also possible that the said respective plurality of images be related. In this manner, the said respective plurality of images can comprise different views of a common subject.

The aforesaid different views can comprise different views of an individuals face.

Yet further, the composite image can be formed from a mosaic of he said elements and the said elements can be all of the same size and/or shape.

The said elements can substantially fill the composite image pattern if required.

In one example, the image can comprise a pixelated image.

Preferably the said spacing and location of the elements can be achieved as stochastically and/or pseudo randomly and/or periodically.

According to another aspect of the present invention, there is provided a composite optical element for verification and/or security applications and comprising a plurality of sets of optical elements, the members of each set sharing the same optical properties and spaced and located within the composite element in a manner seeking to avoid those of another set, the composite optical element being formed by the adjacent location of the spaced elements and wherein the spacing and location is in a manner defined with regard to a security key.

As with the above-mentioned image, the composite optical element can be from a mosaic of said sets of optical elements.

Indeed, the spacing location and shape and configuration of the optical elements serves to mirror those of the image elements noted above.

As should be appreciated, each optical element can comprise a diffractive element which in turn can comprise a diffractive grating and further wherein the members of each set comprise gratings of identical characteristics.

Of course the invention can also provide for a composite optical element arranged to cooperate with a composite image pattern as defined above.

Still further, the invention can provide for a security and/or verification structure comprising a composite image pattern as defined above in combination with a composite optical element as defined above.

According to a further aspect of the present invention, there is provided a method of forming a composite image comprising extracting a plurality of sets of image elements from spaced locations of a respective plurality of different images, and combining the said sets of elements to form the said combined image representative of the said plurality of respective different images, the said spaced location of the elements of each set being achieved in a defined manner to create a security key.

Also, the invention can provide for a method of forming a composite image, wherein the location spacing of the said image elements is achieved stochastically and/or pseudo randomly.

According to still a further aspect of the present invention, there is provided a method of forming a composite optical element comprising forming a plurality of sets of optical elements at spaced locations and wherein the members of each set of elements each share the same optical properties, said spaced location of the elements of each set being achieved in a defined manner so as to create a security key.

The method can include the further step of selectively interfering with selected elements so as to vary the optical properties thereof.

In further detail, the said selected elements can be arranged to be ablated and/or masked so as to affect the role they play during a subsequent verification procedure.

Within the context of the above concept, it should be appreciated that there is provision for a so-called non-personalized hologram wherein the composite optical element, i.e. the field, comprises a set of diffractive cells.

With regard to a so-called non-personalized diffractive structure, the area of such a structure can be equally, however not necessarily regularly, divided on a required number of sub-areas. Each sub-area can be arranged to diffract the light by way of a different, but anticipated, angle or forms a specific diffraction pattern. Further, each sub-area can comprise a set of similarly shaped elements of the identical area. Each element can be occupied by a diffractive grating of predefined parameters (angle, period, shape of the grooves etc.).

As an example, twenty-five angle-positions, i.e. twenty-five sub-areas, of square shape and of size 10×10 micrometers, can be distributed in a field stochastically or pseudo-randomly. The manner/pattern of the spatial distribution of the basic diffractive elements forms a particularly important security item.

As part of a further personalization of a second kind itself, as it specifically determines a specific client exploiting this technique (e.g. an ID issuer), it can further define a required post-processing manner of the decoding and of the image information used for the personalization of the first kind, i.e. the personalization according to a document holder.

Such a non-personalized hologram can be introduced into, for example, the PC ID card by way of a device such as disclosed in PCT/EP2009/066176 and wherein a diffractive structure is directly embossed into the PC foil.

Turning now to the provision of the input graphical data. a particular example can be based on images of the ID holder.

The holder's image (in general the “motif”) is to be recorded from one to N observation angles depending on the manner of desired projection (e.g. a single portrait, flopped multi-angular view from different direction, e.g. “police style triple-photo”, pseudo 3D stereographic portrait). For stereographic imaging it is necessary to follow stereographic principles, an attention has to be paid to the position of the axis of rotation (of a camera or the recorded subject) and a suitable angle among separate views. The position(s) of the camera and/or the position of the rotation axes and the angles between each view are case-sensitive and serve as encrypted information.

Next a set of images can be masked with a given motif. This masking motif relates to a motif of a spatial distribution of the basic diffractive elements. This means, that the only pertinent part of the image is kept for further processing. This part of the image fully corresponds to the area and a dislocation of the basic diffractive elements for this given observation angle.

Particular masked views can be further merged together, and this set then transformed into a binary black and white structure having a graphical resolution, which is greater (by a definition) than the resolution of the input masked images. The ratio between processed/shielded cells inside the area can be linked to the basic diffractive element and can define a brightness level of this element in a final structure, that is, in the holographic portrait, or input data. The manner of data transfer and graphical resolution of the structure and mathematical steps used for these operations are given below.

A subsequent personalization step can form an important aspect of the invention and can involve taking a hologram with no personalization and as created from a set of N areas/cells. Each area can emit the light into a desired/required observation angle. Then, and importantly by a partial destruction or by making the parts of the cells invisible from such areas (binary or grey level) the desired pattern can be revealed. A brightness element can be introduced into the non-personalized hologram via the proper sub-masking and decryption via a proper and very accurate shielding, laser-destruction or overwriting. This synthetically introduces brightness to the pattern and also ultimately defines a desired holographic figure observable by the naked eyes such as a holographic portrait, multi-object or multi-angle portrait like a stereographic holographic portrait of the polycarbonate and similar ID holder.

The required partial destruction of the diffractive element can be realized by laser engraving or with a binary mask. Invisible parts (or shadowing) of the diffractive element can be achieved via a laser exposure of a light sensitive layer overlaying the diffractive structure in a sandwich structure of the polycarbonate ID card etc. The mutual position, and angular registration, of the non-personalized structure and the binary or greylayer image, serve to define the brightness with the 1 micrometer resolution or even better with a minimum trace less than 2 micrometers.

In general there are then N different unitary pictures. Each picture can have unique properties (different motif, different lighting conditions, different positions, size, brightness of the motif etc.).

Each picture can be specifically masked. Thus, there can be N input figures, each occupying 1/N of the entire field area (the total frame), exploiting the positions of the pertinent grating (of a pertinent cell).

The masks are advantageously spatially complimentary and the master can be the sum of all N figures.

Laser gravure, and/or overlaying (covering with a foil) with a shield of defined properties, (preferably transparency) can lead to correspondence to a particular motif or their combinations.

It is considered that the potential applications of this approach are quite broad and can cover a full synthesis of holograms. Various colour changes, 3D, 2D/3D effect, especially the so-called stereo-grams and related effects can also readily be imitated. Further, imaging via lenses, micro-lenses, lens-arrays of either bulk of diffractive nature can be used for displaying the above-mentioned features. This can bring an extra spatial, or at least pseudo-spatial, perception of the feature, similarly to lenticular features, but of a diffractive nature. Various multiple image flops and omnidirectional patterning can be obtained using this approach.

The optical device can comprises a number of elementary cells. Each cell contains a specific diffractive structure like a diffraction grating. The cells of certain properties are spatially distributed. The distribution follows a given code, which ultimately creates a forensic code. The optical device can he further post-processed so as to yield an imitation of a number of holographic and/or diffractive patterns or, more importantly, to lead to a fully synthetic creation of diffractive patterns and similar visual phenomena. This can be achieved through, for example, laser engraving post-processing of the set of diffractive pixel called a field, or via shielding with a film having a prescribed transparency or another optical or diffractive properties.

Another way of introducing coding and masking into a system and method of the invention involves using multiple exposures, when, for example, different dosages can be used while producing the grating structure and during the masking writing, respectively. Accordingly a different developing solution could then be used to distinguish independent exposures.

It should be appreciated that ultimately, the masking can be achieved in a binary manner (e.g. either transparent and non-transparent). However, on a more general level it can be achieved via a variety of grey level coding, thus spanning from transparent to fully opaque. This can also be achieved through a modification of the diffractive efficiency, what is can be done through a variable microrelief height (deepness), leading to changes in the efficiency, and thus brightness and other intensity related properties. Similarly, this can be achieved through use of a variable grating pitch as is known the theory of diffractive gratings.

The basic matrix could also offer a white or white-like pattern, while consisting of a variety of micro-areas diffracting light for a certain wavelength. Hence, the masking (decoding) can also be achieved via covering the pertinent places with a color, or color-like, filter, e.g. following the RGB (red-green-blue) pixels, and thus light color decomposition. This will offer a way of holographic post-processing, such as so-called holographic printing, where the color element is chosen through RGB, or similar, color masking, printed on, or otherwise overlaying, the white-like shining matrix diffractive or reflective structure. This can obviously be exploited for simpler case of black and white, or grey level, overprinting.

Yet further, the diffractive sub-area(s) could also be arranged to direct the light into a given angular and/or azimuthal direction or even more particular directions. This can be achieved when the sub-areas take the shape of axicons, diffractive lenses or their parts, e.g. half of the mentioned elements. Similarly the masking elements can overlay the part of the axicon like or similar sub-areas. This offers another dimension of the invention, that the decoded pattern is then spatially, angularly and azimuthally shaped. The light is then distributed into given directions, so as to achieve a number of multi- and/or omni-directional patterns, while offering an imitation of features known as stereograms, multi-flops and so on. Moreover, this spatial direction of light from each cell can offer a variety of complex synthetically built graphical motifs and patterns. This can further be accompanied with a functional and/or continuous change of the period of gratings, axicons etc., in order to emphasise the white color effect and to appeal for a radiation of a particular part of the spectra. Furthermore, the white and matt like effects can be obtained through introducing randomly or pseudorandomly distributed scaterring areas, preferably of subwavelength size.

In particular, but not exclusively, the invention relates to an optical device that can offer a multiple pattern switches and a related method of manufacture. the method can relate to synthetically written so-called “security holograms” which are also referred to as Diffractive Optically Variable Identification Devices (DOVID) and can be exploited as the personalize identification document.

The invention is described further hearing after, by way of example only, with reference to the accompanying drawings in which:

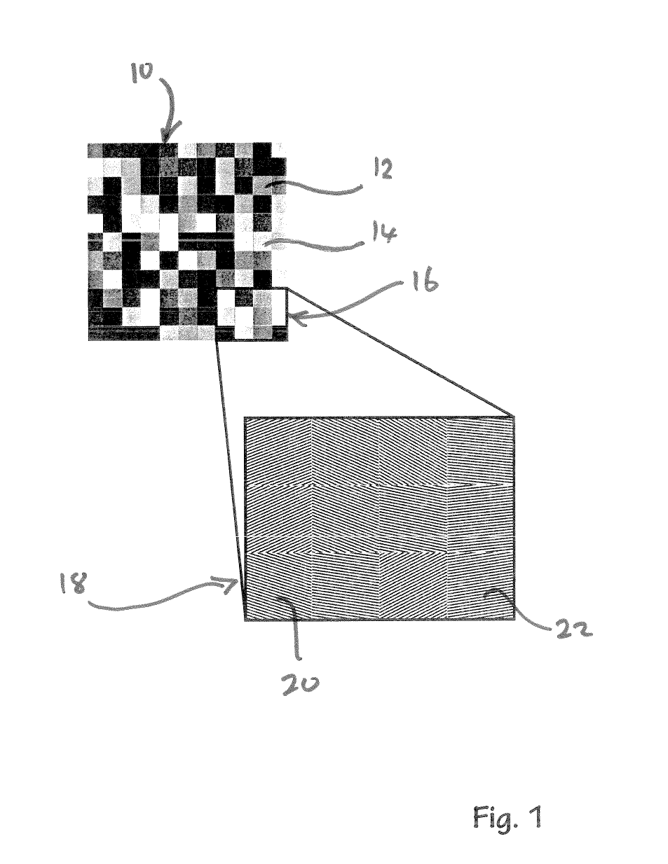

FIG. 1 is an illustration of part of a composite image and related composite optical element according to an embodiment of the present invention;

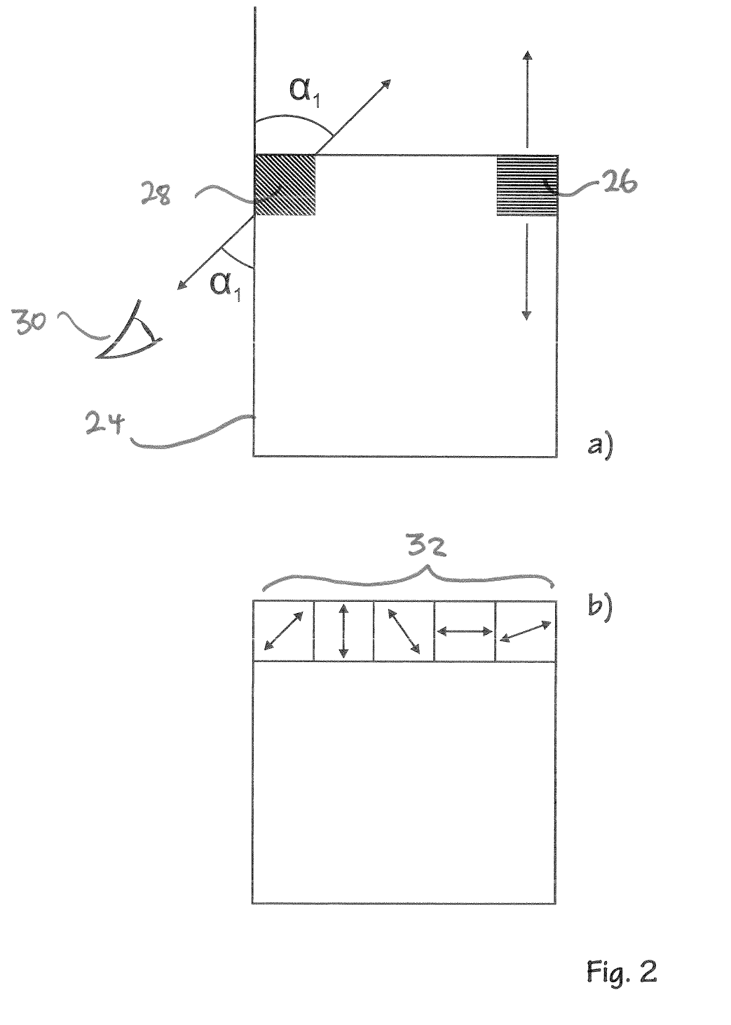

FIGS. 2 a) and b) are schematic representations of elements of a composite element according to an embodiment of the present invention;

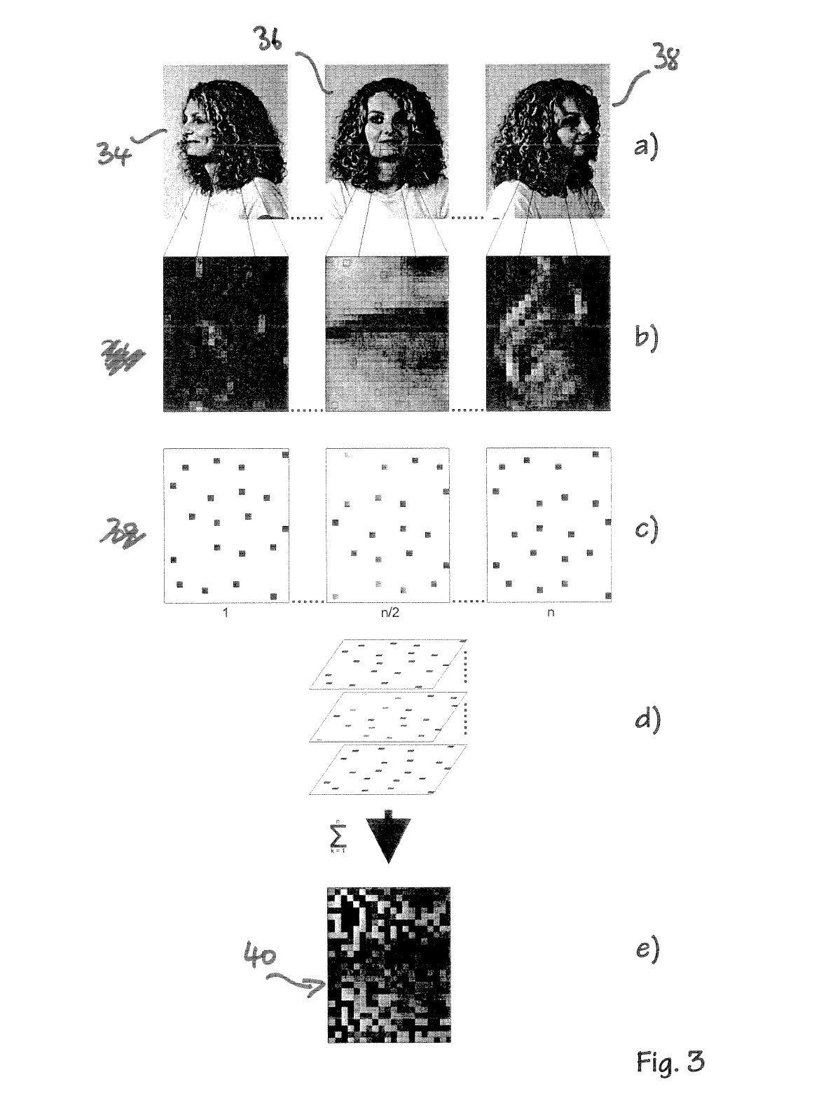

FIGS. 3 a)-e) are illustrations of formation of a composite age according to an embodiment of the present invention;

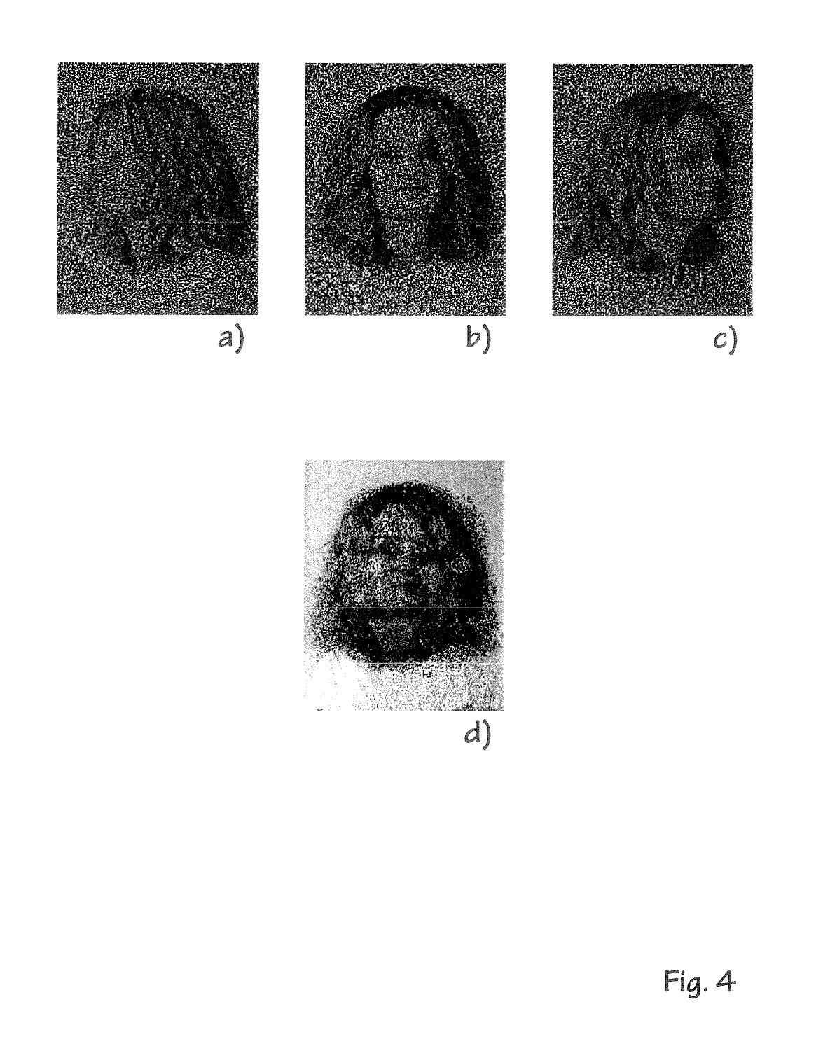

FIGS. 4 a)-d) are illustrations of selectively masked and then combined images according to an embodiment of the present invention;

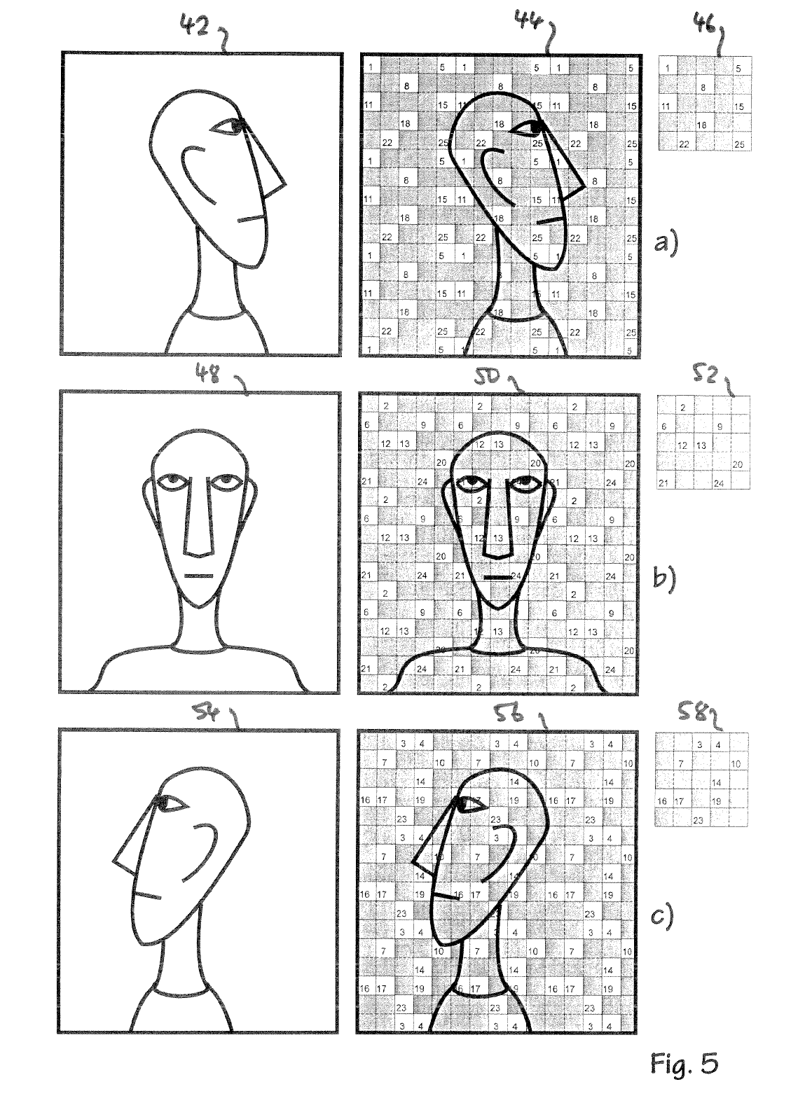

FIGS. 5 a)-c) provides a further schematic illustration of selective masking such that of FIGS. 4a)-c);

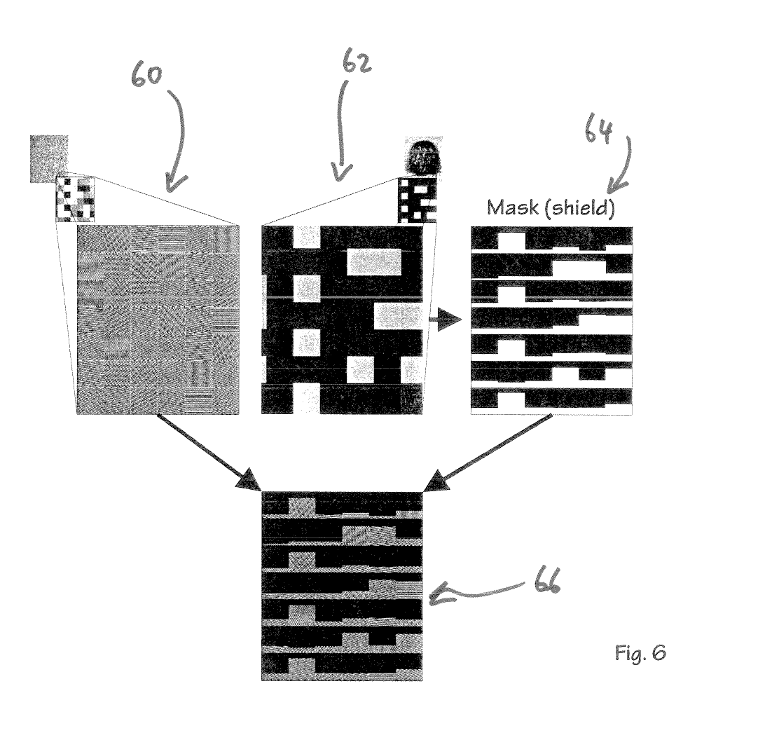

FIG. 6 is a schematic representation of selective masking that can be employed in accordance with a method of the present invention;

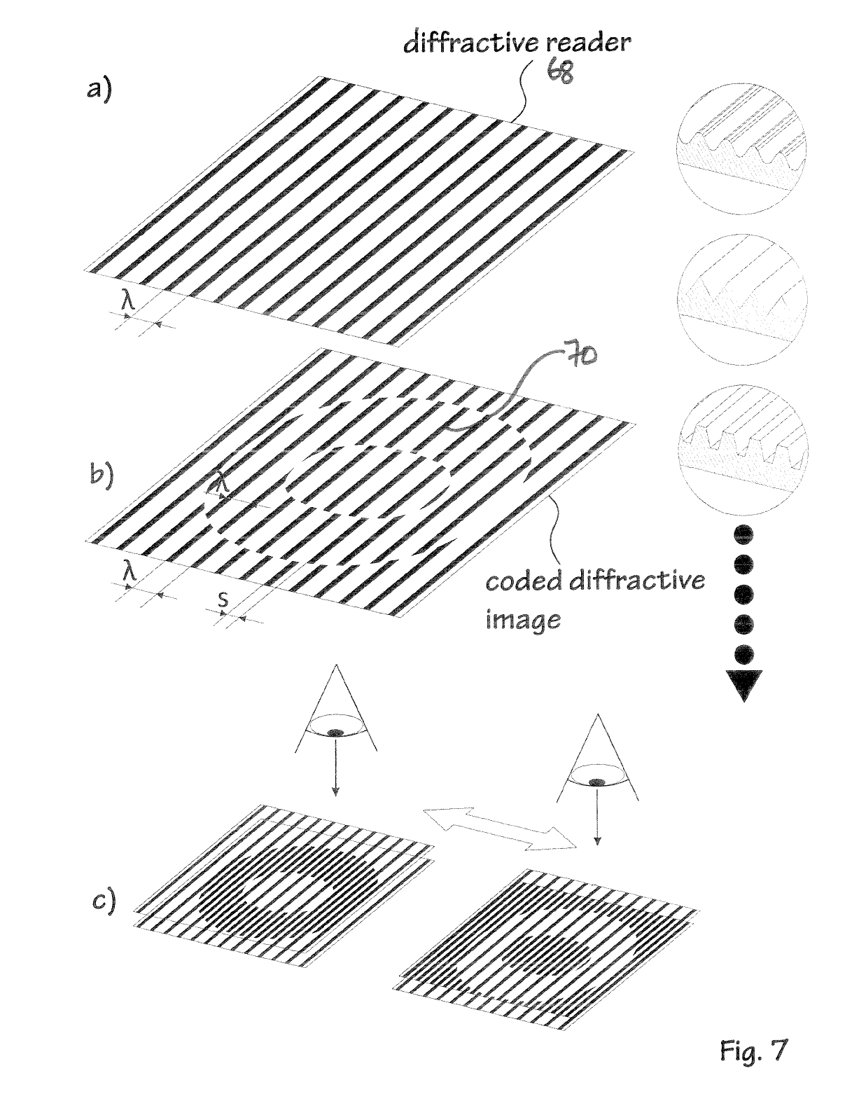

FIGS. 7a)-c) provide a representation of further optical effects that can be achieved by way of the present invention; and

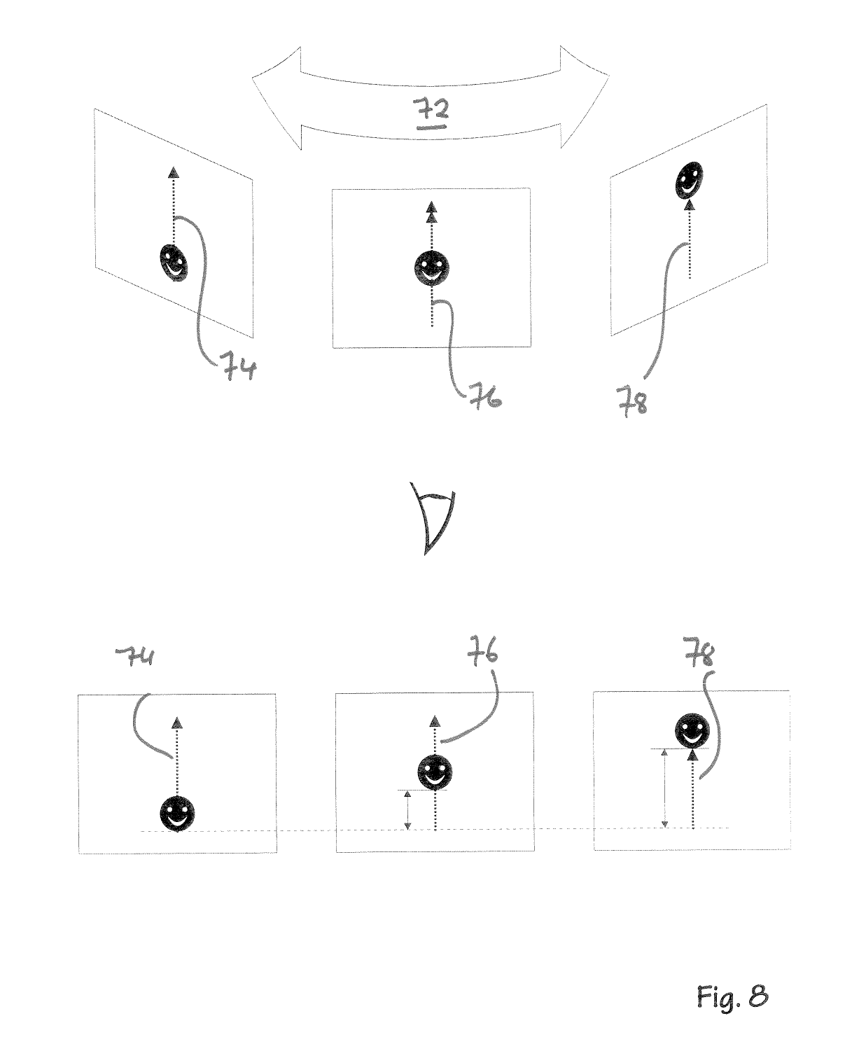

FIG. 8 relates to a yet further aspect, concerning image shift, according to embodiment of the present invention.

Turning first to FIG. 1, there is illustrated framed field (master) 10 comprising m unique cells examples of which are shown 12, 14. The frame 10 is preferably of a rectangular shape, however its shape and area are not practically limited. The cells 12, 14 can be of an arbitrary shape, they do not overlap. From a practical point of view, the cells are adjacent to each other and they preferably fulfil the field most effectively, i.e. they are for example hexagonal, rectangular, square round, elliptically shaped and so on. A corner portion 16 is shown enlarged 18 and comprises specific diffractive structures such as 20, 22 like a linear grating with a given period, grooves shape, tilt of grooves and their curvature.

FIG. 2 is in two parts which show that each cell contains a diffractive grating. Thus the light diffracted is directed/patterned to a pertinent (given) direction and angle or azimuth (a). For example, the light is diffracted perpendicularly to the grooves direction of the linear grating of the cells 26, 28 as illustrated such that the eye 30 sees the light diffracted by cell 28. Obviously the diffracted light follows a rainbow spectrum relative to a period of the grating, as known from elementary optics. Case (b) schematically shows a set of neighbouring cells 32 and the arrows indicate the directions of diffracted light for each cell. A characteristic size of cells is not limited, sizes can theoretically be as small as 1 micrometer, however from a practical reason, they should contain at least several grooves, thus typical sizes are tens of micrometers.

Referring now to FIG. 3, there are various steps shown in the extracting/generating of a composite image arising from the processing of. N separate images a). For example the selection can be from left 34, centre-face 36, and right 38 portraits. In part b) details of a pixelated structure of the input images/figures are shown and in part c) masking and division of the picture is illustrated. The masks are mutually complementary and the spatial distribution can be random, pseudorandom, periodical or otherwise spatially defined. The definition of the spatial distributions is known to the originator/author of the field division and it is later used as the secure key for the whole device. In other words, the knowledge of the specific and prior defined spatial distribution of the masking of every figure is know to the originator of the masking and can be further exploited as a cryptographic key. Considering a reasonably high number of used pixel (approx. thousands or even more up to millions), the coding through a position of each very pixel makes this coding extremely secure. Part d) shows how the N sub-masks can be summed. As can be seen from parts d) and e) of FIG. 3, the basis for the creation of an encrypted image/figure, also referred ti herein as a field area, 40 is its related data which can then be used for laser engraving, shielding, and thus decoding. This advantageously will yield a desired diffraction pattern(s).

FIGS. 4 a)-c) provide a further illustration of the standard personalization of the hologram. FIGS. a), b), and c) show coded/masked left, centre, and right portraits, respectively. As with FIG. 3a) the coding level is for N=3 and so is again achieved with ⅓ density of the entire field shape. Hence, only ⅓ of the original motifs contribute to the composite pattern. The remainder of the information of each picture is effectively ignored. This culminates in FIG. 4d) which shows all N (3) coded images merged together.

In summary therefore regarding FIGS. 3, and 4, for a given figure (say left side photo on FIG. 4a) a level of shielding 1/N of the image/picture/figure is first selected. The sub-pixels of the shield explicitly relate to prior defined gratings of the same kind and so desired functionality. Turning first to the elementary personalization tack, as shown on FIG. 3a), here the intention is to depict left, centre (front face), and right pictures of a person (e.g. an ID holder). Each picture is processed as described above, i.e. ⅓ of the picture/figure is chosen, and data concerning the positions of these pixels is retained. Analogously, a similar procedure is completed for other two figures (front and right ones). Subsequently therefore, the grating field must be originated with respect to the pixels of each from these three pictures/figures. As an example, gratings with a groove tilt, say, −10, 0, ±10 degrees (say three substantially different angles) are chosen. When masked with a decoder (a shield), the left figure/picture can clearly be seen from −10 degrees, the centre figure/picture from 0 degrees and the right figure/picture from +10 degrees. If the decoding via shield does not follow the spatial distribution, one would observe a certain level of crosstalk between the figures of overlapping pattern similarly to FIG. 4d) which can provide for a high degree of security.

The feature of proper decoding leads to the unique personalization of the document, where this special synthetic hologram is applied.

A schematic version of the above is illustrated with reference to FIGS. 5a)-c). Here dark cells are ignored for a given figure, while the white pixel (numbered) cells contribute to a picture (a, b, c). Thus, for the schematic right side, image 42 is represented only by the number of the white pixels in the reduced image 44; and the same holds for the respective further pairs 48, 50 and 54, 56 of the front and left side views. Comparative enlarged views of common top right-hand corner is our illustrated at 46, 52 and 58. Note, the schematics does not relate to a realistic resolution required for this device and are provided simply for clarity of illustration. An easy inspection reveals that the binary sum a+b+c yields a picture with all pixels being playing an active part in the composite image, and thus white in the scheme. Theoretically, not all of the pixels need to be exploited although maximum use serves to maximise the visual efficiency of the device. Ultimately, some unused pixels can also be left empty as a part of the graphical design. It should be appreciated that the a numerals shown in the cells of this schematic representation defines diffraction properties of the cell. In the example therefore, a pseudorandom mode with 25 unique gratings is employed and, as an example, each number relates to a specific direction.

The all important shielding aspect, and the related decrypting step, are illustrated further in FIG. 6. The desire is to collect the desired motif 62 from the grating field 60. Based on the original figures, a proportional part of each pixel is shielded from a given j-th (1, . . . , j, . . . , N) figure as schematically shown on FIG. 6. This can he achieved via a direct laser assisted engraving, thus perturbing and/or erasing or otherwise modulating a fractional part of the pixel or can be produced by a binary (black and white) or a grey level photo mask 64 and to subsequently overlay the master field 66. Having known the positions of the particular cells (thus known the directions of emitted light) effects such as the following—the spatial and angular distribution brightness, colour, relative depth etc.—can be achieved after the hologram has been personalized and decrypted.

It can prove possible to synthetically build features like stereograms, 2D/3D effects etc. to introduce certain effects, e.g. change the order of picture, backward versus fowards motion. The knowledge of the coding (FIGS. 3 and 5) and decoding procedures from FIG. 6 leads to a personalization of the device. Of course, only mutual alignment of the field division and the shielding procedures reveals the true/proper result/pattern.

The distribution of the cells is case sensitive and can be readily customized.

Details of yet a further aspect of the invention are found in FIG. 7 and comprise a special feature would be the so called diffractive Moire, when employing a diffractive reader 68 and an associated field including a subarea 70 with the grating of the same period but slightly shifted by a factor s being a fraction of the grating period, what can be further a function of coordinates, for example.

For diffractive Moiré, and considering a basic diffractive grating with a given period, this grating comprises a sub-area with a grating of the same period, however the grating is slightly shifted by s, where s is a fraction of the grating period. This is shown on a FIG. 7.

Reference is also made to PCT/EP2009/066176 by Vizdal et al. and which discloses origination of such a grating. Such an area comprising the grating, and the grating with a shifted part is observable by the naked eye. Also, the homogeneous area, in other words the area bearing the shifted grating, cannot be observed by the naked eye. A diffractive reader 68 is provided and comprises a grating of the identical period as the grating of the base diffractive structure/area. When the reader 68 is closely positioned on the base structure with grooves being mutually parallel, the motif with shifted grating will be visible, because of the s shift. This is the so-called diffractive moiré, as actually know from the classical moiré phenomena. However this approach introduces the diffractive sized features into this phenomenon.

Another application, and as illustrated in FIG. 8, is very unique feature exploiting this principle leading to the imitation of the so called motion effect (see Crane et al. US2007/0273143 A1). Features of movement with the entire decode device in one direction of arrow 72, however the visual appearance follows different one of arrows 74, 76 and 78. Like horizontal (move of the device) versus vertical (visually observable) motion effect. The directions and/or 2D/3D) perception can be of a nearly arbitrary mutual relation as desired during the origination.

The shield from FIG. 6 may also comprise lenses or related optical imaging devices for either each cell or a group or subgroup of cells in order to offer visual phenomena like taught in US2007/0273143 A1 and related prior art.

Further, the grating mask can be made via a procedure such as that disclosed in PCT/EP2010/037834 and/or WO2010/037834 by Jermolajev of al. The shielding can be processed via a direct laser engraving or shielding with a foil bearing an information in a form of the transparency at the position of each pertinent pixel as described before.

The laser engraving of the number of the pixels may appear quite difficult, because of a required very precise positioning and aiming at each pixel location during overwriting the desired information. This can be done directly or is achieved by an additional machine readable or sensible reading like introduced, e.g. in WO 03/001440 A1 by Petterson et al. introducing small markers, predefined jitter like displacement of the pixels (either size or position) or a pre-allocated markers for a certain subarea. The laser beam would then be spatially led by recognizing this internal signature and would be positioned/focused into the pertinent pixel or subarea. This is further described in the following.

Specially crafted holographic marks (e.g. lenxicons, special linear gratings, nanographics) or nonholographic ones such as points of basic graphical elements, are placed at particular positions of the hologram in order to create a pattern. The pattern is constructed so that each part of the predefined (small) size is unique in the whole pattern and thus allows one to unambiguously determine a position of a part of the hologram scanned.

The pattern consists of symbols placed on a rectangular grid. A symbol may be formed by a choice from a set of holographic marks or by a displacement (by a fixed amount, small with respect to the grid distance) of the mark from the ordinary position, or by the combination of both. Symbols read off the predefined-size part of the pattern forms a codeword. A set of all code-words forms a code. The size of code-words—number of symbols is chosen so that code-words are unique and each codeword unambiguously determine the grid position, where the codeword is read-off from.

The code may be constructed in a way that every two code-words of the code differ in more than one symbol. An eventual error which may have occurred during a read-off of one or more symbol of a code-word can be detected and if required corrected by a selection of the most similar (i.e. the closest) valid code-word instead.

The present invention can therefore provide for a novel and advantageous manner of origination of diffractive elements arranged in an encrypted way to yield a desired (preferably) naked-eye-observable effect after a specific decrypting of the features.

Furthermore, the features of the invention discussed herein can be advantageously combined with other covert, as well as overt, diffractive and related security features and techniques.

As should therefore be appreciated from the above description and definitions, a particular aspect of the principle of the invention is a method involving production of a diffractive master, also referred to as the “field”. This master contains a certain number of cells, each possessing a specific diffractive structure as shown on FIG. 2. The originator/author of that field is aware of the spatial distribution together with the diffractive properties of each cell. This distribution forms the (security) key of the device. Some of the cells will have identical diffractive properties, such as shown in FIG. 5. As seen, there is quite a number of “1s”, “2s” etc. When all of these are combined, the field itself will appear to he a perfect diffuser, as there will be several directions being randomly spread all over the field.

The further explanation, for simplicity, and considers just one mask, thus one graphical motif as a basic decoding. Assuming that the cells “1” have a grating that for a certain direction produces a red appearance, through for example laser ablation, or shielding, the field with the motif being the same as the distribution of 1s (where is 1, there is transparent shield, otherwise black) it is possible to yield the effect of the field being observed from the far field as appearing red. Further, if the field mesh is quite dense, the same could be achieved for more complicated motifs such as the portraits illustrated above. For example, there is a “5” twice inside the face, and any “5” outside of the face would appear black. If it is required to have “5” only in the face, although sparse in density, the observer would see the face with the properties of “5”, i.e. a given colour in a given direction etc. The mutual knowledge of the specific grating in the field and exploitation of the knowledge of this distribution of the pertinent cell will lead to a successful decoding. Hence the observer would see the motif as shown on FIG. 5a.

With regard to FIG. 3, still the originator/author keeps in mind that the cells on the field at the position of c) left (also numbered as 1) will have identical diffractive properties, e.g. emitting the light to a certain direction.

Returning to FIG. 6, the field is on the left. The centre part shows the part (⅓) of the pixels density. Based on the contrast of the motif (a portrait) a shield prescription (right) can then be made. This is applied on the field in the form or covering film, or the bare field is “blackened” by laser engraving or otherwise. This results in the lower figure, which would be observable from distance as a continuous pattern.

In one mode, tilting is done by a movement of an observer. Again certain sub-groups of cells radiate in a given direction and nowhere else. We can allow, block or partially block this direction at the places of the motif.

Of course, the “key” represented by the spacing and location is kept separately as “know-how” and only revealed on a restricted basis. This key can then be applied to selectively destroy/distort the field accordingly, or a film identical to the mask shield of FIG. 6 can be employed over the field.

Although it could prove possible to prepare a mask for one image, it is preferred to have one mask revealing all three pictures/figures. When looking from left, one would see the left one, from centre the centre one etc.

In general therefore, the method can employ a generic synthesis of holograms. However there is also provided a pseudorandom mask with a key defining how to handle each cell (to let or to erase for binary case etc). Any misplacement of the relation between the key and the mask will lead to obvious crosstalk between the images, or absolute failure in decrypting and so will be readily indicative of attempted miss-use, fraudulent activity etc. and so can exhibit a strong potential for security/anti-counterfeit/verification measures and applications.

1. A composite image field for verification and/or security applications and comprising a plurality of sets of image elements, wherein members of each set are from the same one of a respective plurality of images and are spaced and located within the composite image in a manner seeking to avoid those of another set, the composite image being formed by the adjacent location of the spaced elements and wherein the spacing and location is in a defined manner serving to create a security key.

2. A composite image as claimed in claim 1, wherein the said respective plurality of images are unrelated.

3. A composite image as claimed in claim 1, wherein the said respective plurality of images are related.

4. A composite image as claimed in claim 3, wherein the said respective plurality of images comprise different views of a common subject.

5. A composite image as claimed in claim 3, wherein the said respective plurality of images comprise different views of an individual's face.

6. A composite image as claimed in claim 1 and formed from a mosaic of the said elements.

7. A composite image as claimed in claim 1 wherein the said elements are all of the same size and/or shape.

8. A composite image as claimed in claim 1 wherein the said elements substantially fill the composite image field.

9. A composite image as claimed in claim 1 wherein the said elements are square.

10. A composite image as claimed in claim 1 comprising a pixelated image and wherein each of the said elements comprises a pixel of that image.

11. A composite image as claimed in claim 1 wherein each of the said image elements form part of a greyscale image.

12. A composite image as claimed in claim 1 wherein the said spacing and location of the elements is achieved in a stochastic and/or pseudo random manner.

13. A composite optical element for verification and/or security applications and comprising a plurality of sets of optical elements, the members of each set sharing the same optical properties and spaced and located within the composite element in a manner seeking to avoid those of another set, the composite optical element being formed by the adjacent location of the spaced elements and wherein the spacing and location is in a manner defined for providing a security key.

14. A composite optical element as claimed in claim 13 and formed from a mosaic of said sets of optical elements.

15. A composite optical element as claimed in claim 13, and arranged to present the appearance of a diffuser.

16. A composite optical element as claimed in claim 13, wherein each optical element with in the said sets comprises a diffractive element.

17. A composite optical element as claimed in claim 16, wherein each diffractive element comprises a diffractive grating and further wherein the members of each set comprise gratings with identical characteristics.

18. A composite optical element as claimed in claim 13 wherein each member of the sets of elements is of the same size.

19. A composite optical element as claimed in claim 13, wherein each member of the sets of elements if of the same shape.

20. A composite optical element as claimed in claim 13, wherein each element of the said sets comprising a square element.

21. A composite optical element as claimed in claim 13, and wherein each optical element of each set comprises a pixel element.

22. A composite optical element as claimed in claim 13, and arranged to cooperate with a composite image field.

23. A security and/or verification structure comprising a composite image field as claimed in claim 1 in combination with a composite optical element.

24. A structure as claimed in claim 23 and arranged such that movement of the structure relative to a user serves to determine which of the respective plurality of the images is visible.

25. A structure as claimed in claim 23, wherein movement of the composite optical element relative to the composite image field serves to determine which of the respective plurality of images is visible.

26. A method of forming a composite image comprising extracting a plurality of sets of image elements from spaced locations of a respective plurality of different images, and combining the said sets of elements to form the said combined image representative of the said plurality of respective different images, the said spaced location of the elements of each set being achieved in a defined manner to create a security key.

27. A method as claimed in claim 26, and including the step of forming a mosaic of image elements.

28. A method as claimed in claim 26, wherein each of the elements is formed of the same size and/or shape.

29. A method as claimed in claim 26, and forming the said plurality of sets of image elements to substantially fill the field of the composite image.

30. A method as claimed in claim 26, and forming the image elements as squares.

31. A method as claimed in claim 26, and forming the composite image as pixelated image wherein each of the said image elements comprises a pixel.

32. A method as claimed in claim 26, wherein the combined image comprises a greyscale image.

33. A method of forming a composite image as claimed in claim 26, wherein the location and spacing of the said image elements is achieved stochastically and/or pseudo randomly.

34. A method of forming a composite optical element comprising forming a plurality of sets of optical elements at spaced locations and wherein the members of each set of elements each share the same optical properties, said spaced location of the elements of each set being achieved in a defined manner so as to create a security key.

35. A method as claimed in claim 34, and including the step of forming a mosaic of image elements.

36. A method as claimed in claim 34, and including the step of forming a diffuser element.

37. A method as claimed in claim 14, wherein each element is formed as a diffractive element.

38. A method as claimed in claim 37, wherein each diffractive element comprises a diffractive grating.

39. A method as claimed in claim 37, wherein the diffractive properties of each element are the same for each member of each group respectively.

40. A method as claimed in claim 34, wherein each of the said elements has the same size and/or shape.

41. A method as claimed in claim 34, and including a further step of selectively interfering with selected elements so as to vary the optical properties thereof.

42. A method as claimed in claim 41, wherein the said selected elements are arranged to be ablated and/or masked so as to affect the role they play during a subsequent verification procedure.

43. A method of security verification including the step of combining a composite optical element as claimed in claim 13, with a composite image field and wherein the spacing and location of the optical elements is defined by the spacing and location of the said image elements.

44-48. (canceled)
